(19) United States
(12) Patent Application Publication
(10) Pub. No.: US 2011/0169337 A1
(43) Pub. Date: Jul. 14, 2011

(54) POWER FEED DEVICE, POWER RECEIVING DEVICE, AND WIRELESS POWER FEED SYSTEM

(75) Inventor: Osamu Kozakai, Kanagawa (JP)

(73) Assignee: SONY CORPORATION, Tokyo (JP)

(21) Appl. No.: 12/977,264

(22) Filed: Dec. 23, 2010

(30) Foreign Application Priority Data
Jan. 8, 2010 (JP) 2010-002874

(51) Int. Cl. H01F 38/14

(52) U.S. Cl. 307/104

(57) ABSTRACT

A power feed device includes: a power generator configured to generate power that should be fed; a power feed element configured to be formed of a coil fed with power generated by the power generator; a resonance element configured to be coupled to the power feed element by electromagnetic induction; and a variable matching unit configured to include a function for impedance matching at a point of feed of the power to the power feed element, wherein a diameter of the power feed element is changeable, and the variable matching unit is capable of changing the diameter of the power feed element.

### BACKGROUND OF THE INVENTION

1. Field of the Invention

The present invention relates to a power feed device, a power receiving device, and a wireless power feed system based on a non-contact power feed system for non-contact (wireless) supply and reception of power.

2. Description of the Related Art

An electromagnetic induction system is known as a system for wireless supply of power.

Furthermore, in recent years, wireless power feed and charge systems employing a system called the magnetic field resonance system based on an electromagnetic resonance phenomenon are attracting attention.

Presently, in the non-contact power feed system based on the electromagnetic induction system, which has been already widely used, the power feed source and the power feed target (power receiving side) need to share magnetic flux. Therefore, the power feed source and the power feed target need to be disposed extremely close to each other for power sending with high efficiency, and axis alignment of the coupling is also important.

In contrast, the non-contact power feed system employing the electromagnetic resonance phenomenon has advantages that power can be transmitted across a longer distance compared with the electromagnetic induction system and the transmission efficiency is not greatly lowered even when the accuracy of axis alignment is somewhat low, because of the principle of the electromagnetic resonance phenomenon.

Besides the magnetic field resonance system, the electric field resonance system is also known as the system based on the electromagnetic resonance phenomenon.

For example, Japanese Patent Laid-open No. 2001-185939 (hereinafter referred to as Patent Document 1) discloses a non-contact data carrier system of the electromagnetic induction type employing resonance.

The technique disclosed in Patent Document 1 has a configuration in which power is transmitted from a power feed coil connected to a power feed circuit to a resonant coil by electromagnetic induction, and the frequency and the quality factor are adjusted by a capacitor and a resistor connected to the resonant coil.

### SUMMARY OF THE INVENTION

In the configuration example disclosed in Patent Document 1, the resonant frequency is changed by the resonant coil unit. Therefore, there is the following disadvantage in use for impedance adjustment of the coil for power feed.

Specifically, although the resonant frequency adjustment, which is adjustment of the imaginary part of the impedance, is possible, the real part is adjusted based on the resistance value and therefore the loss is large. In the disclosed method, it is used for adjustment of the quality factor conversely.

Furthermore, there is another disadvantage that the loss is large if the quality factor of the resonant coil is high.

There is a need for the present invention to provide a power feed device, a power receiving device, and a wireless power feed system capable of impedance matching with low loss.

According to a first embodiment of the present invention, there is provided a power feed device including a power generator configured to generate power that should be fed, a power feed element configured to be formed of a coil fed with power generated by the power generator, a resonance element configured to be coupled to the power feed element by electromagnetic induction, and a variable matching unit configured to include a function for impedance matching at a point of feed of the power to the power feed element. The diameter of the power feed element is changeable, and the variable matching unit is capable of changing the diameter of the power feed element.

According to a second embodiment of the present invention, there is provided a power receiving device including a resonance element configured to receive transmitted power based on a magnetic field resonance relationship, a power feed element configured to be formed of a coil that is coupled to the resonance element by electromagnetic induction and is fed with received power, a resonance element configured to be coupled to the power feed element by electromagnetic induction, and a variable matching unit configured to include a function for impedance matching at a connecting part between the power and a load of the power feed element. The diameter of the power feed element is changeable, and the variable matching unit is capable of changing the diameter of the power feed element.

According to a third embodiment of the present invention, there is provided a wireless power feed system including a power feed device, and a power receiving device configured to receive power transmitted from the power feed device based on a magnetic field resonance relationship. The power feed device includes a power generator to generate power that should be fed, a power feed element formed of a coil fed with power generated by the power generator, a resonance element coupled to the power feed element by electromagnetic induction, and a variable matching unit including a function for impedance matching at a point of feed of the power to the power feed element. The diameter of the power feed element is changeable, and the variable matching unit is capable of changing the diameter of the power feed element. The power receiving device includes a resonance element that receives power transmitted from the power feed device based on a magnetic field resonance relationship, a power feed element formed of a coil that is coupled to the resonance element by electromagnetic induction and is fed with received power, a resonance element coupled to the power feed element by electromagnetic induction, and a variable matching unit including a function for impedance matching at a connecting part between the power and a load of the power feed element. The diameter of the power feed element is changeable, and the variable matching unit is capable of changing the diameter of the power feed element.

The embodiments of the present invention enable variable impedance matching with low loss.

### BRIEF DESCRIPTION OF THE DRAWINGS

FIG. 1 is a block diagram showing a configuration example of a wireless power feed system according to an embodiment of the present invention;

FIG. 2 is a diagram schematically showing the relationship between coils on the power transmitting side and coils on the power receiving side in the wireless power feed system according to the embodiment;

FIG. 3 is a diagram schematically showing a configuration including a diameter change function of a power feed coil and a variable matching circuit according to the embodiment;

FIG. 4 is a diagram for explaining the principle of a magnetic field resonance system;

FIG. 5 is a diagram showing the frequency characteristic of the coupling amount in the magnetic field resonance system;

FIG. 6 is a diagram showing the relationship between the distance between resonance elements and the coupling amount in the magnetic field resonance system;

FIG. 7 is a diagram showing the relationship between the resonance frequency and the distance between the resonance elements, providing the maximum coupling amount, in the magnetic field resonance system;

FIG. 8 is a diagram showing one example of a general variable matching circuit;

FIG. 9 is a diagram schematically showing a structure to switch the diameter of the power feed coil in a power feed device and a power receiving device according to the embodiment; and

FIG. 10 is a diagram showing the power characteristic in association with change in the resonance coil interval (distance between the power transmitting and receiving sides) in the embodiment and comparative examples.

### DETAILED DESCRIPTION OF THE PREFERRED EMBODIMENT

An embodiment of the present invention will be described below in association with the drawings.

The order of the description is as follows.
1. Configuration Example of Wireless Power Feed System
2. Diameter Change Function of Power Feed Coil and Variable Matching Circuit
3. Principle of Magnetic Field Resonance System
4. Control Processing for Diameter of Power Feed Coil

### <1. Configuration Example of Wireless Power Feed System>

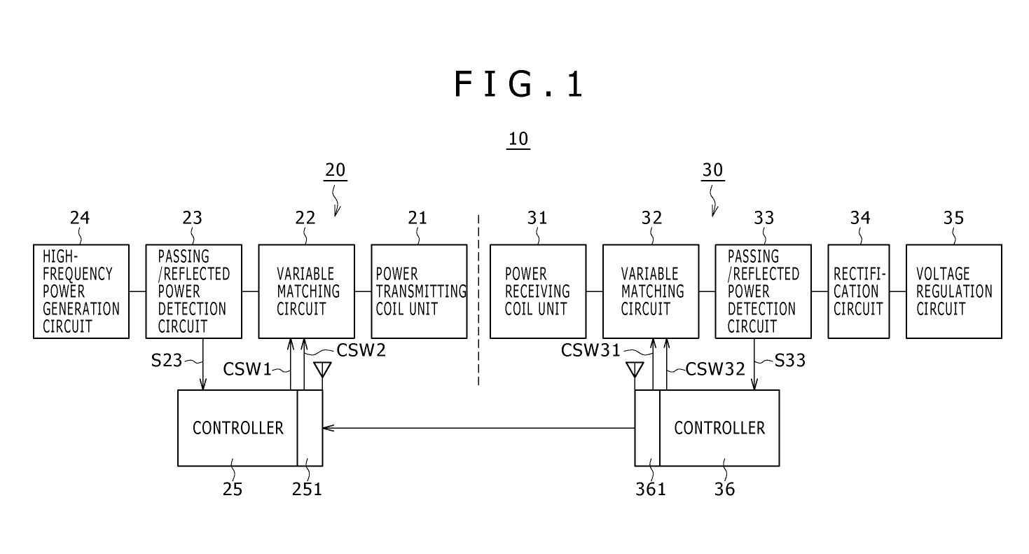

FIG. 1 is a block diagram showing a configuration example of a wireless power feed system according to the embodiment.

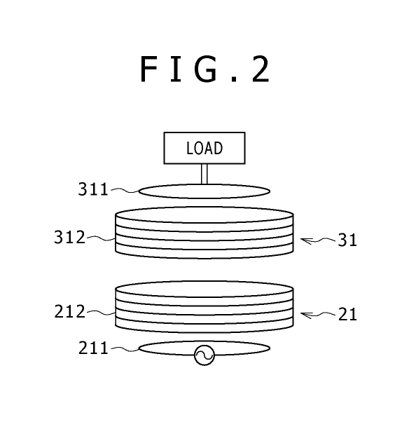

FIG. 2 is a diagram schematically showing the relationship between coils on the power transmitting side and coils on the power receiving side in the wireless power feed system according to the embodiment.

This wireless power feed system 10 has a power feed device 20 and a power receiving device 30.

The power feed device 20 includes a power transmitting coil unit 21, a variable matching circuit 22, a passing/reflected power detection circuit 23, a high-frequency power generation circuit 24, and a controller 25 as a control unit.

The power transmitting coil unit 21 has a power feed coil 211 as the power feed element and a resonance coil 212 as the resonance element. Although the resonance coil is referred to also as the resonant coil, the term “resonance coil” will be used in the description of the present embodiment.

The power feed coil 211 is formed of an air core coil fed with an AC current.

The power feed coil 211 is so configured that its diameter can be changed in accordance with a switch control signal by the variable matching circuit 22 serving also as a diameter changer.

The resonance coil 212 is formed of an air core coil coupled to the power feed coil 211 by electromagnetic induction. When the self-resonant frequency of the resonance coil 212 corresponds with that of a resonance coil 312 in the power receiving device 30, the resonance coil 212 enters the magnetic field resonance relationship to transmit power with high efficiency.

### <2. Diameter Change Function of Power Feed Coil and Variable Matching Circuit>

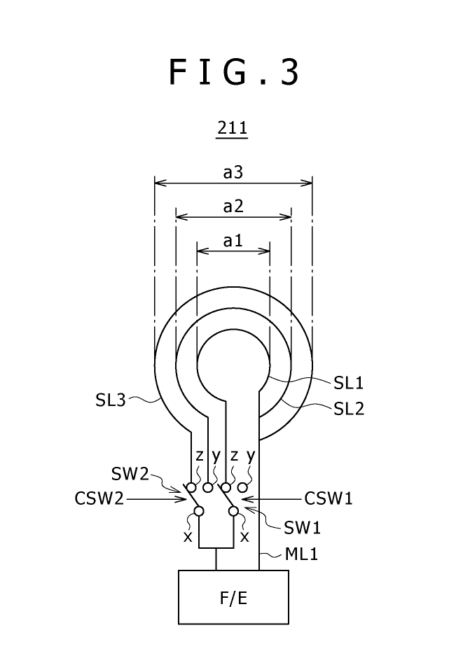

FIG. 3 is a diagram schematically showing a configuration including the diameter change function of the power feed coil and the variable matching circuit according to the present embodiment.

In the power feed coil 211 in FIG. 3, a backbone line part ML1 whose one end is connected to a front end unit F/E as the power feeder.

Furthermore, the power feed coil 211 has air core coil parts SL1, SL2, and SL3 that each have one end connected to the other end of the backbone line part ML1 and have diameters a1, a2, and a3 different from each other.

The air core coil parts SL1, SL2, and SL3 are so formed that their diameters a1, a2, and a3 have a relationship of a1<a2<a3.

The power feed coil 211 and the variable matching circuit 22 according to the present embodiment have a switch unit SW1, SW2 for changing the diameter a of the power feed coil 211.

This switch unit SW1, SW2 can be configured as part of the variable matching circuit 22 or part of the power transmitting coil unit 21 for example.

The switch unit SW1, SW2 has terminals x, y, and z. In the switch SW1, the terminal x is connected to the front end unit F/E and the terminal y is kept at the non-connected state. In addition, the terminal z is connected to the other end of the air core coil part SL1.

In the switch SW2, the terminal x is connected to the front end unit F/E and the terminal y is connected to the other end of the air core coil part SL2. In addition, the terminal z is connected to the other end of the air core coil part SL3.

The switches SW1 and SW2 are independently switched in accordance with switch control signals CSW1 and CSW2.

Specifically, for example when the switch control signals CSW1 and CSW2 specify a first state, the switches SW1 and SW2 are so controlled that the terminal x and the terminal y are connected to each other.

In this case, the diameter of the power feed coil 211 is the diameter a2 of the air core coil part SL2.

When the switch control signals CSW1 and CSW2 specify a second state, the switches SW1 and SW2 are so controlled that the terminal x and the terminal z are connected to each other.

In this case, the diameter of the power feed coil 211 is substantially the diameter al of the air core coil part SL1.

At this time, both the air core coil part SL1 and the air core coil part SL3 are kept at the connected state. However, the diameter of the power feed coil 211 is a1, which is the smaller diameter of those of the air core coil parts SL1 and SL3.

The variable matching circuit 22 has a function for impedance matching at the power feed point of the power feed coil 211 in accordance with the control signals CSW1 and CSW2 supplied by the controller 25.

The passing/reflected power detection circuit 23 has a function to detect the passing and reflected power in power transmission between the circuits 24 and 22, and supplies the detection result as a signal S23 to the controller 25.

The passing/reflected power detection circuit 23 supplies high-frequency power generated by the high-frequency power generation circuit 24 to the variable matching circuit 22.

The high-frequency power generation circuit 24 generates high-frequency power for wireless power transmission.

The high-frequency power generated by the high-frequency power generation circuit 24 is supplied to the variable matching circuit 22 via the passing/reflected power detection circuit 23, and fed (applied) to the power feed coil 211 in the power transmitting coil unit 21.

The controller 25 receives the detection result by the passing/reflected power detection circuit 23, and outputs the control signals CSW1 and CSW2 to the variable matching circuit 22 so that high-efficiency power transmission can be carried out through impedance matching in the variable matching circuit 22.

In other words, the controller 25 carries out control so that the self-resonant frequency of the resonance coil 212 may correspond with that of the resonance coil 312 in the power receiving device 30 and the resonance coil 212 may enter the magnetic field resonance relationship to transmit power with high efficiency.

The controller 25 includes a wireless communication unit 251 having a wireless communication function, and can give and receive control information including diameter change information and so forth and information on the detection result of the passing/reflected power to and from a controller 36 on the side of the power receiving device 30 by wireless communication. For the wireless communication, e.g. the Bluetooth or the RFID can be employed.

The power receiving device 30 includes a power receiving coil unit 31, a variable matching circuit 32, a passing/reflected power detection circuit 33, a rectification circuit 34, a voltage regulation circuit 35, and the controller 36.

The power receiving coil unit 31 has a power feed coil 311 as the power feed element and the resonant (resonance) coil 312 as the resonance element.

To the power feed coil 311, an AC current is fed from the resonance coil 312 by electromagnetic induction.

The power feed coil 311 is so configured that its diameter can be changed by the variable matching circuit 32 as a diameter changer.

As the configuration of the diameter changer for the power feed coil 311 by the power feed coil 311 and the variable matching circuit 32, a configuration similar to the above-described one on the side of the power feed device 20 can be employed. Therefore, the specific description thereof is omitted.

In this case, the front end unit F/E functions as the power receiver.

The resonance coil 312 is formed of an air core coil coupled to the power feed coil 311 by electromagnetic induction. When the self-resonant frequency of the resonance coil 312 corresponds with that of the resonance coil 212 in the power feed device 20, the resonance coil 312 enters the magnetic field resonance relationship to receive power with high efficiency.

The variable matching circuit 32 has a function for impedance matching at the load end of the power feed coil 311 in accordance with control signals CSW31 and CSW32 supplied by the controller 36.

The passing/reflected power detection circuit 33 has a function to detect the passing and reflected power in power transmission between the circuits 32 and 34 responding to the received AC power, and supplies the detection result as a signal S33 to the controller 36.

The passing/reflected power detection circuit 33 supplies the received AC power to the rectification circuit 34.

The rectification circuit 34 rectifies the received AC power to DC power and supplies it to the voltage regulation circuit 35.

The voltage regulation circuit 35 converts the DC power supplied by the rectification circuit 34 to DC voltage suitable for the specifications of the electronic apparatus as the supply target, and supplies the regulated DC voltage to the electronic apparatus.

The controller 36 receives the detection result by the passing/reflected power detection circuit 33, and outputs the control signals CSW31 and CSW32 to the variable matching circuit 32 so that high-efficiency power transmission can be carried out through impedance matching in the variable matching circuit 32.

The controller 36 includes a wireless communication unit 361 having a wireless communication function, and can give and receive the control information and the information on the detection result of the passing/reflected power to and from the controller 25 on the side of the power feed device 20 by wireless communication.

The operation of the above-described configuration will be described below, with main focus on the principle of the magnetic field resonance system and the control processing for the diameter of the power feed coils 211 and 311.

### <3. Principle of Magnetic Field Resonance System>

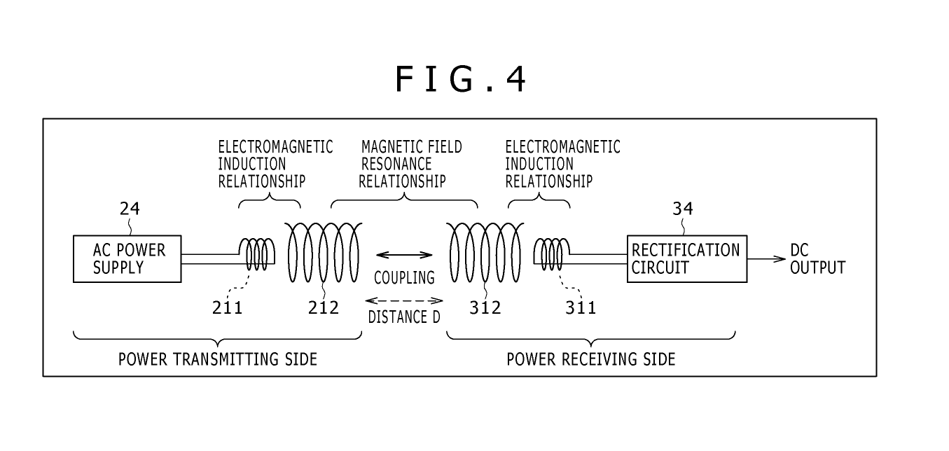

First, the principle of the magnetic field resonance system will be described in association with FIG. 4 to FIG. 7.

FIG. 4 is a diagram for explaining the principle of the magnetic field resonance system.

The following description of the principle will be so made that the power feed coil is treated as the power feed element and the resonance coil is treated as the resonance element.

The systems based on the electromagnetic resonance phenomenon include the electric field resonance system and the magnetic field resonance system. FIG. 4 is a diagram of a wireless (non-contact) power feed system of the magnetic field resonance system, and shows a basic block in which the power feed source side and the power receiving side have a one-to-one correspondence relationship.

In terms of association with the configuration of FIG. 1, the power feed side has the AC power supply 24, the power feed element 211, and the resonance element 212, and the power receiving side has the resonance element 312, the power feed element 311, and the rectification circuit 34.

Because FIG. 4 is a diagram for explaining the basic principle, the variable matching circuit 22, the passing/reflected power detection circuit 23, and the controller 25 are omitted on the side of the power feed device 20.

On the side of the power receiving device 30, the variable matching circuit 32, the passing/reflected power detection circuit 33, the voltage regulation circuit 35, and the controller 36 are omitted.

Each of the power feed elements 211 and 311 and the resonance elements 212 and 312 is formed of an air core coil.

On the power feed side, the power feed element 211 and the resonance element 212 are strongly coupled to each other by electromagnetic induction. Similarly, on the power receiving side, the power feed element 311 and the resonance element 312 are strongly coupled to each other by electromagnetic induction.

When the self-resonant (resonance) frequencies of the respective air core coils as the resonance elements 212 and 312 on both of the power feed side and the power receiving side correspond with each other, the resonance elements 212 and 312 enter the magnetic field resonance relationship, so that the coupling amount becomes the maximum and the loss becomes the minimum.

An AC current is supplied from the AC power supply 24 to the power feed element 211, and a current is induced in the resonance element 212 by electromagnetic induction.

The frequency of the AC current generated by the AC power supply 24 is set identical to the self-resonant frequency of the resonance element 212 and the resonance element 312.

The resonance element 212 and the resonance element 312 are disposed with the relationship of the magnetic field resonance with each other, and AC power is supplied in a wireless (non-contact) manner from the resonance element 212 to the resonance element 312 at the resonance frequency.

On the power receiving side, a current is supplied from the resonance element 312 to the power feed element 311 by electromagnetic induction, and a DC current is made and output by the rectification circuit 34.

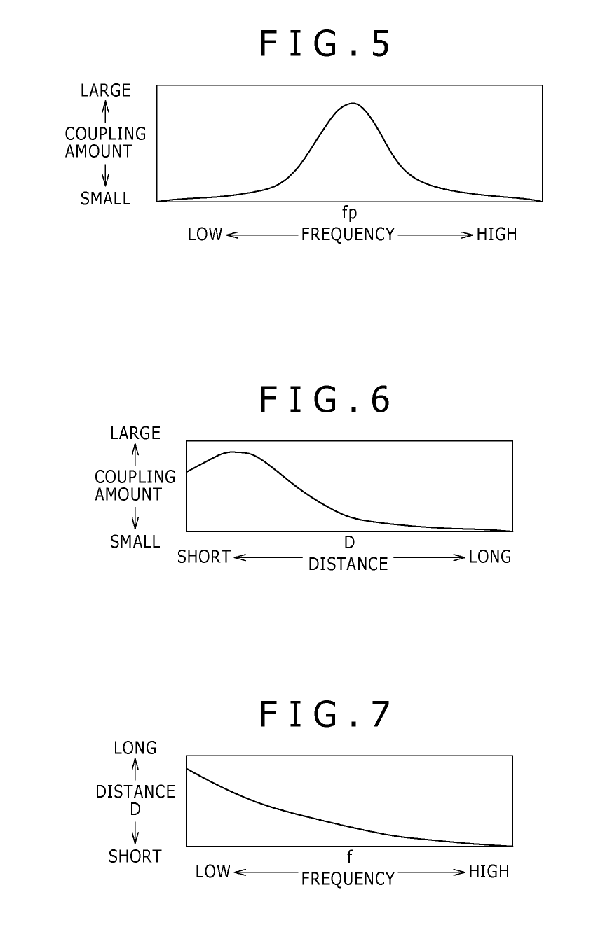

FIG. 5 is a diagram showing the frequency characteristic of the coupling amount in the magnetic field resonance system.

In FIG. 5, the abscissa indicates the frequency fp of the AC power supply and the ordinate indicates the coupling amount.

FIG. 5 shows the relationship between the frequency of the AC power supply and the coupling amount.

From FIG. 5, it turns out that the frequency selectivity is shown due to the magnetic resonance.

FIG. 6 is a diagram showing the relationship between the distance between the resonance elements and the coupling amount in the magnetic field resonance system.

In FIG. 6, the abscissa indicates the distance D between the resonance elements and the ordinate indicates the coupling amount.

FIG. 6 shows the relationship between the coupling amount and the distance D between the resonance element 212 on the power feed side and the resonance element 312 on the power receiving side.

From FIG. 6, it turns out that the distance D providing the maximum coupling amount exists with a certain resonance frequency.

FIG. 7 is a diagram showing the relationship between the resonance frequency and the distance between the resonance elements, providing the maximum coupling amount, in the magnetic field resonance system.

In FIG. 7, the abscissa indicates the resonance frequency f and the ordinate indicates the distance D between the resonance elements.

FIG. 7 shows the relationship between the resonance frequency and the distance D between the resonance element 212 on the power feed side and the resonance element 312 on the power receiving side, providing the maximum coupling amount.

From FIG. 7, it turns out that the maximum coupling amount can be obtained by setting the resonance element interval wide when the resonance frequency is low and can be obtained by setting the resonance element interval narrow when the resonance frequency is high.

### <4. Control Processing for Diameter of Power Feed Coil>

FIG. 2 shows the basic configuration of the wireless power feed system 10 of the magnetic field resonance type.

In the wireless power feed system 10 of the magnetic field resonance type, impedance matching at the power feed point and the load end is very important.

In general, the impedance matching is carried out through adjustment of the interval and diameter ratio between the power feed coil and the resonance coil on both of the power transmitting side and the power receiving side.

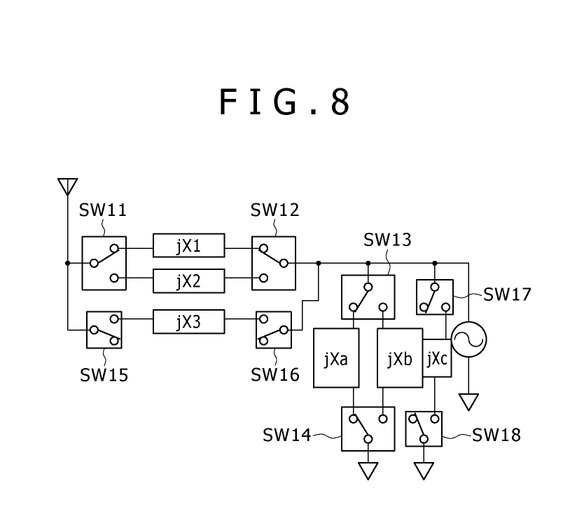

FIG. 8 is a diagram showing one example of a general variable matching circuit.

In general, series and parallel reactance elements are necessary to adjust the real part of the impedance, and four switches SW11, SW12, SW13, and SW14 are necessary to switch them.

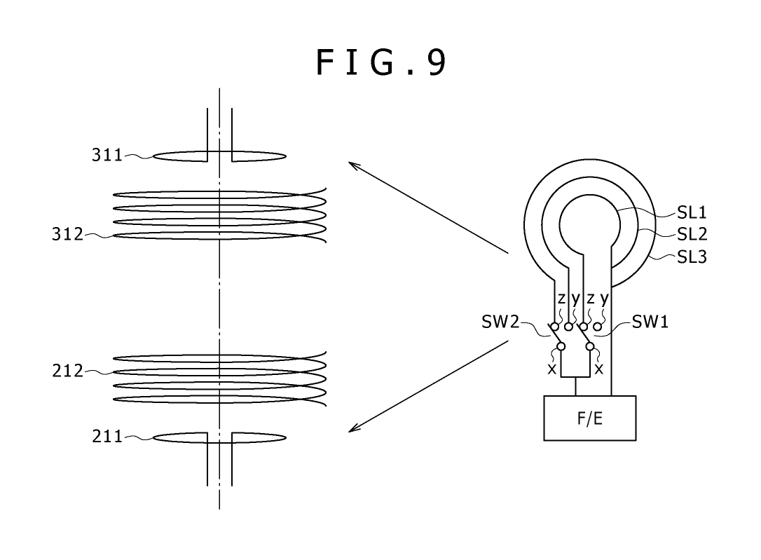

FIG. 9 is a diagram schematically showing the structure to switch the diameter of the power feed coil in the power feed device and the power receiving device according to the present embodiment.

In the present embodiment, the impedance matching structure of the magnetic field resonance type is utilized to switch the diameter of the power feed coils 211 and 311, and thereby a matching switch circuit with low loss can be realized.

In general, a resonance coil having a high quality factor is used in a wireless power feed system of the magnetic field resonance type, and therefore the loss is large if a circuit is connected to the resonance coil.

In contrast, the impedance of the power feed coil is converted to low impedance, and thus the loss is small although a circuit is connected to the power feed coil.

Furthermore, in the general variable matching circuit shown in FIG. 8, the eight switches SW11 to SW18 are necessary to change the real part of the impedance in three ways. In contrast, in the method shown in FIG. 3 and FIG. 9 according to the embodiment of the present invention, the change is possible with two switches SW1 and SW2, and thus the change function can be realized at low cost.

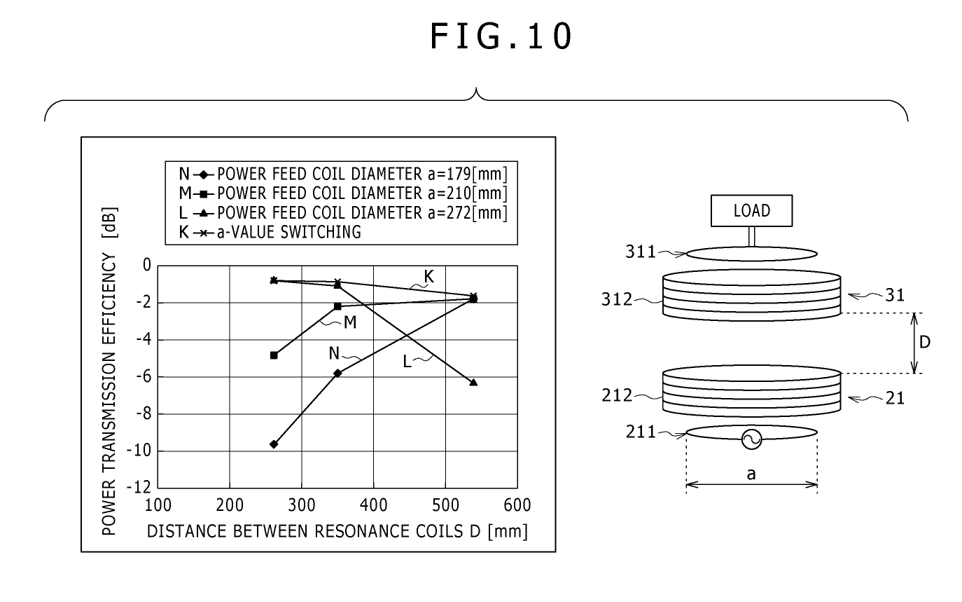

FIG. 10 is a diagram showing the power characteristic in association with change in the resonance coil interval (distance between the power transmitting and receiving sides) in the present embodiment and comparative examples.

In FIG. 10, the abscissa indicates the distance D between the resonance coils and the ordinate indicates the power reception level.

In FIG. 10, the curve indicated by K shows the characteristic obtained when the diameter a of the power feed coil of the present embodiment can be changed.

The curve indicated by L corresponds to a characteristic shown as the comparative example, and shows the characteristic obtained when the diameter a of the power feed coil is fixed at 272 [mm].

The curve indicated by M corresponds to a characteristic shown as the comparative example, and shows the characteristic obtained when the diameter a of the power feed coil is fixed at 210 [mm].

The curve indicated by N corresponds to a characteristic shown as the comparative example, and shows the characteristic obtained when the diameter a of the power feed coil is fixed at 179 [mm].

Normally, in the wireless power feed system of the magnetic field resonance type, readjustment of the impedance is necessary when the interval between the resonance coils on the power transmitting and receiving sides (distance between the power transmitting and receiving sides) is changed.

For example, referring to FIG. 10, if the diameter a of the power feed coil is fixed at 272 mm, as shown by the curve L, large characteristic deterioration is found when the distance D between the resonance coils is 550 mm.

If the diameter a of the power feed coil is fixed at 179 mm, as shown by the curve N, a favorable characteristic is exhibited when the distance between the resonance coils is 550 mm, whereas large characteristic deterioration is found when the distance D between the resonance coils is around 250 mm.

In contrast, if the diameter a of the power feed coil is variable like in the present embodiment, as shown by the curve K, a favorable characteristic in which characteristic deterioration is small although the distance D between the resonance coils is changed in the range from 250 mm to 550 mm.

As a configuration example of the present embodiment, the configuration of FIG. 3 and FIG. 9, in which switching among three diameters is carried out, is employed. However, it is also possible to employ a configuration in which air core coil parts of a larger number of diameters are formed and switching among the diameters is carried out by the switch unit.

The controllers 25 and 36 carry out control in such a manner that the diameter a of the power feed coils 211 and 311 becomes larger when the distance D between the resonance coils is shorter (the coils are closer to each other) and the diameter a of the power feed coils 211 and 311 becomes smaller when the distance D is longer (the coils are farther from each other).

As described above, the present embodiment can achieve the following advantageous effects.

Specifically, the present embodiment can realize a low-loss, low-cost variable matching function.

This makes it possible to maintain a favorable characteristic through optimum impedance matching even when the distance between the resonance coils on the power transmitting and receiving sides (distance between the power transmitting and receiving sides) is changed.

The present application contains subject matter related to that disclosed in Japanese Priority Patent Application JP 2010-002874 filed in the Japan Patent Office on Jan. 8, 2010, the entire content of which is hereby incorporated by reference.

It should be understood by those skilled in the art that a variety of modifications, combinations, sub-combinations and alterations may occur, depending on design requirements and other factors as far as they are within the scope of the appended claims or the equivalents thereof.

What is claimed is:

1. A power feed device comprising:
a power generator configured to generate power that should be fed;
a power feed element configured to be formed of a coil fed with power generated by the power generator;
a resonance element configured to be coupled to the power feed element by electromagnetic induction; and
a variable matching unit configured to include a function for impedance matching at a point of feed of the power to the power feed element, wherein
a diameter of the power feed element is changeable, and
the variable matching unit is capable of changing the diameter of the power feed element.

2. The power feed device according to claim 1, wherein
the power feed element and the variable matching unit include:
a front end unit that feeds power generated by the power generator to the power feed element;
a backbone line part whose one end is connected to the front end unit;
a plurality of coil parts that have diameters different from each other and each have one end connected to the backbone line part; and
a switch unit that selectively connects the other end of the plurality of coil parts to the front end unit.

3. The power feed device according to claim 1, further comprising:
a power detector configured to detect a state of power to be transmitted; and
a control unit configured to instruct the variable matching unit to set the diameter of the power feed element depending on a detection result by the power detector.

4. The power feed device according to claim 3, wherein
the control unit carries out control in such a manner that the diameter of the power feed element becomes larger when distance between the resonance element and a resonance element on a power receiving side is shorter and the diameter of the power feed element becomes smaller when the distance is longer.

5. A power receiving device comprising:
a resonance element configured to receive transmitted power based on a magnetic field resonance relationship;
a power feed element configured to be formed of a coil that is coupled to the resonance element by electromagnetic induction and is fed with received power;
a resonance element configured to be coupled to the power feed element by electromagnetic induction; and
a variable matching unit configured to include a function for impedance matching at a connecting part between the power and a load of the power feed element, wherein
a diameter of the power feed element is changeable, and
the variable matching unit is capable of changing the diameter of the power feed element.

6. The power receiving device according to claim 5, wherein
the power feed element and the variable matching unit include:
a front end unit that receives power received by the power feed element;
a backbone line part whose one end is connected to the front end unit;
a plurality of coil parts that have diameters different from each other and each have one end connected to the backbone line part; and
a switch unit that selectively connects the other end of the plurality of coil parts to the front end unit.

7. The power receiving device according to claim 5, further comprising:
a power detector configured to detect a state of received power; and
a control unit configured to instruct the variable matching unit to set the diameter of the power feed element depending on a detection result by the power detector.

8. The power receiving device according to claim 7, wherein
the control unit carries out control in such a manner that the diameter of the power feed element becomes larger when distance between the resonance element and a resonance element on a power transmitting side is shorter and the diameter of the power feed element becomes smaller when the distance is longer.

9. A wireless power feed system comprising:
a power feed device; and
a power receiving device configured to receive power transmitted from the power feed device based on a magnetic field resonance relationship, wherein
the power feed device includes
a power generator to generate power that should be fed,
a power feed element formed of a coil fed with power generated by the power generator,
a resonance element coupled to the power feed element by electromagnetic induction, and
a variable matching unit including a function for impedance matching at a point of feed of the power to the power feed element,
a diameter of the power feed element is changeable,
the variable matching unit is capable of changing the diameter of the power feed element,
the power receiving device includes
a resonance element that receives power transmitted from the power feed device based on a magnetic field resonance relationship,
a power feed element formed of a coil that is coupled to the resonance element by electromagnetic induction and is fed with received power,
a resonance element coupled to the power feed element by electromagnetic induction, and
a variable matching unit including a function for impedance matching at a connecting part between the power and a load of the power feed element,
a diameter of the power feed element is changeable, and
the variable matching unit is capable of changing the diameter of the power feed element.

10. The wireless power feed system according to claim 9, wherein
the power feed element and the variable matching unit in the power feed device include:
a front end unit that feeds power generated by the power generator to the power feed element;
a backbone line part whose one end is connected to the front end unit;
a plurality of coil parts that have diameters different from each other and each have one end connected to the backbone line part; and
a switch unit that selectively connects the other end of the plurality of coil parts to the front end unit.

11. The wireless power feed system according to claim 9, wherein
the power feed element and the variable matching unit in the power receiving device include:
a front end unit that receives power received by the power feed element;
a backbone line part whose one end is connected to the front end unit;
a plurality of coil parts that have diameters different from each other and each have one end connected to the backbone line part; and
a switch unit that selectively connects the other end of the plurality of coil parts to the front end unit.

12. The wireless power feed system according to claim 9, wherein
at least one of the power feed device and the power receiving device includes:
a power detector to detect a state of power; and
a control unit to instruct the variable matching unit to set the diameter of the power feed element depending on a detection result by the power detector.

13. The wireless power feed system according to claim 12, wherein
the control unit carries out control in such a manner that the diameter of the power feed element becomes larger when distance between the resonance element in the power feed device and the resonance element in the power receiving device is shorter and the diameter of the power feed element becomes smaller when the distance is longer.

14. The wireless power feed system according to claim 12, wherein
the control unit is disposed in the power feed device and the power receiving device, and
the control unit in the power feed device and the control unit in the power receiving device are capable of wirelessly giving and receiving information to and from each other.
